(19) United States
(12) Patent Application Publication
(10) Pub. No.: US 2019/0362037 A1
(43) Pub. Date: Nov. 28, 2019

(54) ANISOTROPIC FATIGUE AND CREEP TESTING PROTOCOL

(71) Applicant: SABIC Global Technologies B.V., Bergen op Zoom (NL)

(72) Inventors: Amin SEDIGHIAMIRI, Bergen op Zoom (NL); Tim Bernardus VAN ERP, Bergen op Zoom (NL)

(21) Appl. No.: 16/477,658

(22) PCT Filed: Jan. 12, 2018
(86) PCT No.: PCT/EP2018/050794

§ 371 Date: Jul. 12, 2019

Related U.S. Application Data
(60) Provisional application No. 62/445,964, filed on Jan. 13, 2017.

(51) Int. Cl. G06F 17/50

(52) U.S. Cl. CPC G06F 17/5009; B29K 2101/12; G06F 2217/44

(57) ABSTRACT

Accelerated testing protocol systems and methods for testing fiber-reinforced thermoplastic are described. This accelerated testing protocol includes a hybrid approach that includes a combination of modeling and experimental testing. In particular, a reduced set of physical tests are combined with thermoplastic structural models (e.g., phenomenological models) to provide a full characterization of the fiber-reinforced thermoplastic. This accelerated testing protocol significantly reduces test time associated with anisotropic fatigue and creep failure characterization of the fiber-reinforced thermoplastic over a wide range of temperatures, applied loads, and loading angles.

### PRIORITY

This application claims the benefit of priority to U.S. Provisional Patent Application Ser. No. 62/445,694, filed on Jan. 13, 2017, the benefit of priority of which is claimed hereby, and which is incorporated by reference herein in its entirety.

### BACKGROUND

There is an increasing use of fiber-reinforced thermoplastics in various industries. Reinforced polymer composites are being more and more widely used for making load-bearing structural parts, for example in aircraft structure, automotive and industrial applications. Reinforced polymer composite articles comprise one or more reinforcement structures in intimate intermixed contact with a polymer matrix. Commonly, the reinforcement structures comprise one or more fibrous reinforcement structures, such as one or more reinforcing fibers. Reinforcing fibers in polymer composite articles may be arranged in discontinuous forms, e.g., non-associated discontinuous reinforcing fibers (also known as staple reinforcing fibers or chopped reinforcing fibers). Alternatively, Reinforcing fibers in polymer composite articles may be arranged in continuous forms, such as woven fabrics, nonwoven fabrics, unidirectional tapes, automatic tape laying structures, wound filaments, tailored fiber preforms, fiber layup structures, and shaped-fiber members.

Fiber-reinforced thermoplastics show a time-dependent failure behavior (e.g., “creep behavior” or “fatigue behavior”). The failure behavior is linked to the fiber orientation (e.g., anisotropic failure) of the part. For example, a fiber-reinforced thermoplastic exhibits one time-to-failure value when deformed in parallel with the direction of the fiber reinforcement, and may exhibit a much different time-to-failure value when deformed perpendicular to the direction of the fiber reinforcement.

Computer-aided design and simulation (e.g., virtual product development) of fiber-reinforced thermoplastics is also growing extensively, as it reduces time-to-market and reduces physical prototyping. A key step for accurate simulation is providing accurate input material data, however the accuracy of the input material data requires many physical tests to provide an accurate characterization of the anisotropic time-to-failure of a fiber-reinforced thermoplastic. Generation of input data sufficient for conducting simulations may include a full characterization of anisotropic failure under creep and fatigue loading conditions, which may include static and dynamic tests at various applied stresses, temperatures, and specimen orientations (i.e., fiber orientations) tailored to the end-product loading conditions. This anisotropic failure characterization usually results in very long experimental time and extremely high costs. Long lead-time and high costs have been deterring the widespread use of anisotropic time-to-failure simulation during the design and development of fiber-reinforced thermoplastic parts. To improve the application development cycle of fiber-reinforced thermoplastic parts, a solution is needed that will reduce the long lead-time and high cost associated with anisotropic time-to-failure simulation.

### SUMMARY

The present disclosure describes a system and method for an accelerated testing protocol for fiber-reinforced thermoplastic, where the accelerated testing protocol is embedded in an integrated simulation framework. This accelerated testing protocol significantly reduces test time associated with anisotropic fatigue and creep failure characterization of the fiber-reinforced thermoplastic over a wide range of temperatures, applied loads, and loading angles. This accelerated testing protocol includes a hybrid approach that includes a combination of modeling and experimental testing. In particular, a reduced set of physical tests are combined with thermoplastic structural models (e.g., phenomenological constitutive models) to provide a full characterization of the fiber-reinforced thermoplastic. This approach enables predicting the applied stress dependence of the cycle-to-failure and creep time failure. As discussed herein, this stress-induced time-to-failure information may be represented graphically as an S-N or S-T curve, which shows cycles-to-failure (N) or creep time-to-failure (T) as a function of applied stress (S), i.e. maximum applied cyclic stress in case of fatigue testing or constant applied stress in case of creep testing.

In an embodiment, this accelerated testing protocol can significantly reduce the number of tests needed for providing input for simulations, and can significantly reduce the net test time. This accelerated testing protocol can also provide simulated material input data (e.g., virtual material input data) in a broader range of applied stress, temperature, and orientation than measured data (e.g., actual data). Using these various features, this accelerated testing protocol can improve simulation reliability by providing access to a wider range of material data, can reduce simulation time and cost, and can reduce time and costs associated with an accelerated product development cycle.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The figures and accompanying descriptions below provide information and example results for testing time-dependent failure behavior, which can include, creep behavior testing, fatigue behavior testing, or a combination thereof.

FIG. 1 shows a block diagram of anisotropic failure testing.

FIGS. 2A-2C show graphs of tensile fatigue test results.

FIGS. 3A-3D show graphs of depicting steps within the accelerated test protocol.

FIG. 4 shows a graph of a tensile fatigue test result evaluation.

FIGS. 5A-5B show graphs of test improvement metrics when using the accelerated testing protocol.

FIGS. 6A-6B show graphs of simulation validation results.

### DETAILED DESCRIPTION

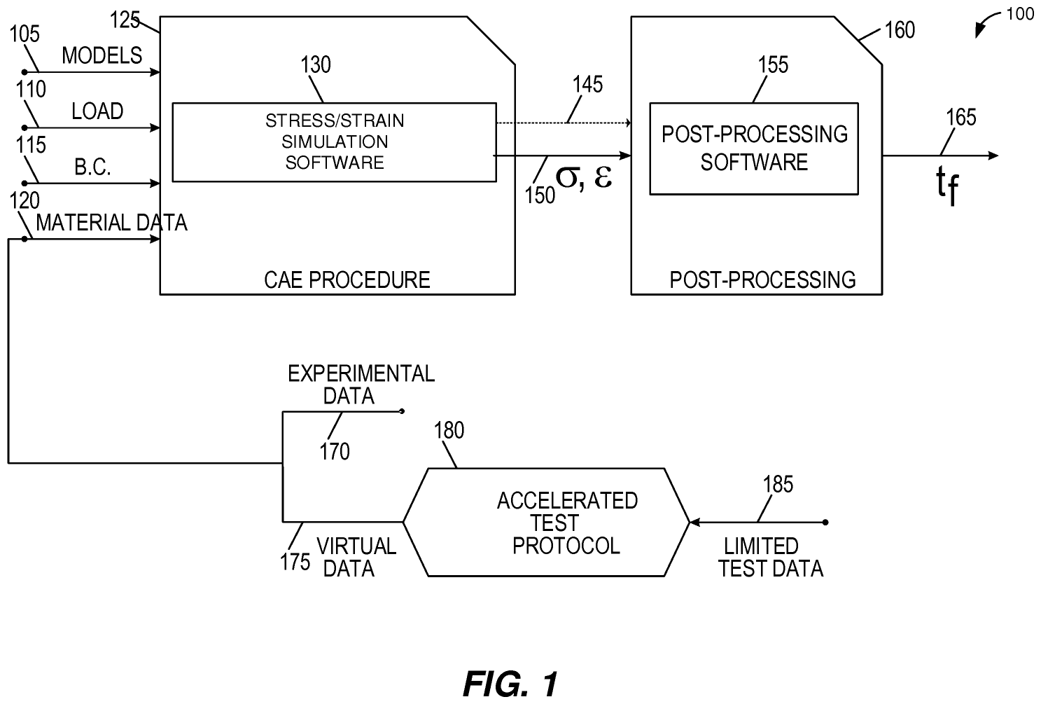

FIG. 1 shows a block diagram of anisotropic failure testing 100. In an example, testing 100 includes an integrated simulation workflow comprising a computer-aided engineering (CAE) procedure block 125 and post-processing block 160. The CAE procedure 125 may take various inputs, such as material models 105, service load information 110, boundary conditions 115 (e.g., fixations, assemblies, etc.), and material data 120. The CAE procedure block 125 and post-processing block 160 may include one or more commercial simulation software tools integrated together to account for the fiber or flow orientation-induced anisotropy of the time-to-failure values. In an example, the CAE procedure block 125 includes one or more simulation software tools 130, such as stress/strain simulation software, mold-filling simulation software, or other supporting simulation software. In an example, post-processing block 160 includes one or more post-processing software tools 155, which may receive simulation tool outputs 145 and a (stress) and c (strain) information 150 and provide post-processed output 165. However, the output accuracy of the CAE procedure block 125 and post-processing block 160 depends on the accuracy of the anisotropic material input data (e.g., S-N or S-T curves) at various load levels, temperatures, load angles, load type (e.g., constant loading, sine wave loading, block wave loading etc.), loading frequency, and load amplitude. Because the accuracy of the CAE procedure block 125 and post-processing block 160 depends on many simulated and measured input variables, generating the simulated and measured input variable needed by the CAE procedure block 125 and post-processing block 160 may be a time-consuming and costly process.

In an example, the anisotropic failure testing 100 includes an accelerated test protocol 180. The accelerated test protocol 180 takes limited test data 185 and outputs virtual data 175. The accelerated test protocol 180 may be used to generate simulated material data (e.g., virtual fatigue data), and may be used in addition to or as a replacement for the experimental data 170. The accelerated testing protocol 180 uses a hybrid experimental and modeling approach. In an example, the accelerated testing protocol 180 may use initial limited test data to fit parameters of the models, after which the combination of the models can generate the virtual material data across a broad range of test configurations. In an embodiment, the accelerated test protocol 80 provides a significant reduction in a number of tests and a significant reduction in net test time.

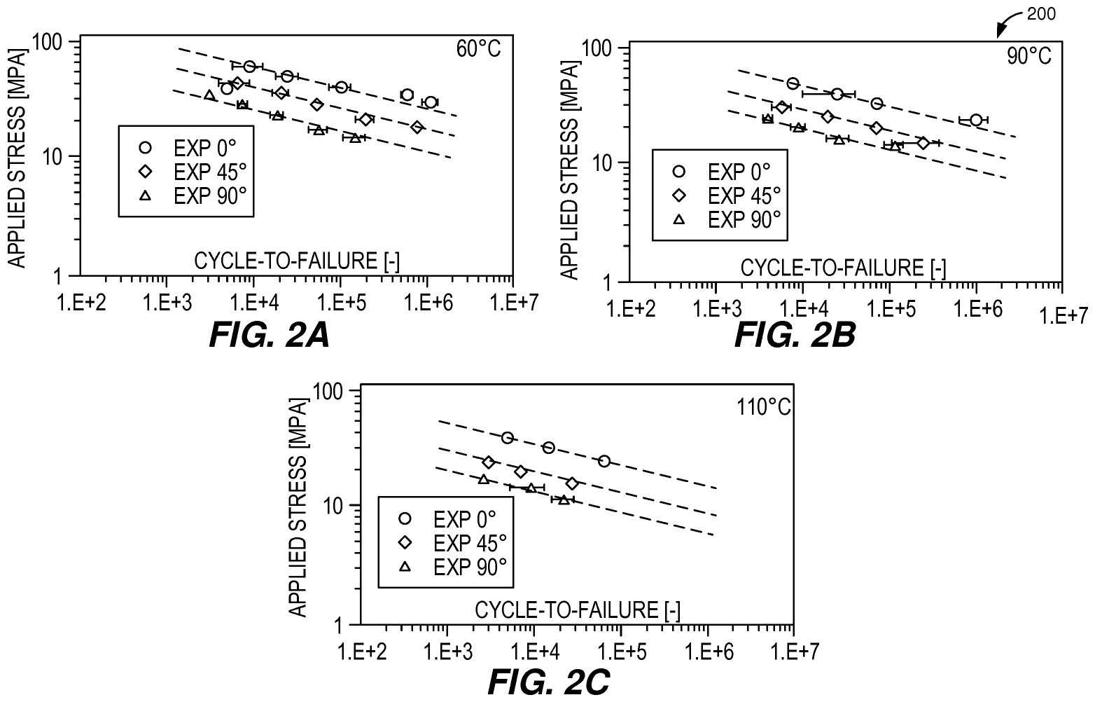

FIGS. 2A-2C show graphs of tensile fatigue test results 200. The tensile fatigue test results 200 show cycle-to-failure for various test conditions. The tensile fatigue test results 200 are based on a limited test using a combination of material models to generate virtual data. This virtual data is generated by extrapolating the limited test data over cycles and temperature ranges that were not measured. This virtual data can be combined with or used instead of experimental data.

As shown in FIGS. 2A-2C, the applied stress dependence of cycle-to-failure (i.e., the S-N curve) is depicted as a linear relation on a double logarithmic scale for various orientation and temperatures. For example, FIG. 2A shows cycle-to-failure results for tests conducted at 60° C., FIG. 2B shows cycle-to-failure results for tests conducted at 90° C., and FIG. 2C shows cycle-to-failure results for tests conducted at 110° C. Each of these tests is conducted with stress applied at various orientations relative to the direction of the fibers within the fiber-reinforced thermoplastic under test. As expected, the fiber-reinforced thermoplastic is most resistant to failure when the stress is applied to align with the fiber, shown in FIGS. 2A-2C as 0° relative to the fibers. The effect of fiber orientation-induced anisotropy on the cycle-to-failure is significant. For example, there is a factor of almost 200 difference in the cycle-to-failure between a constant maximum stress applied at orientations of 0° and 90°. This variation in cycle-to-failure and time-to-failure of fiber-reinforced thermoplastic materials (i.e., fiber orientation-induced anisotropy) is significant in characterization of fatigue and creep performance.

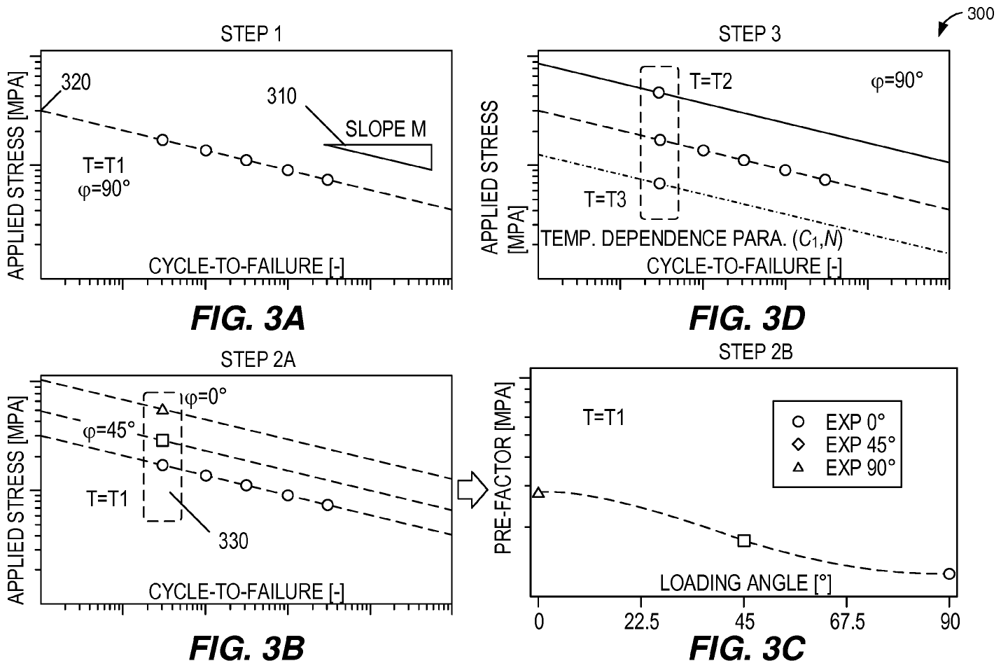

FIGS. 3A-3D show graphs of depicting steps within the accelerated test protocol 300. On the double logarithmic scale shown in FIGS. 3A-3D, the approximately linear fatigue performance characterization is shown as a dashed line. The slope 310 and y-intercept 320 of these lines is determined based on the power law model:

$$σ = {{c}_{f} ( \frac{{t}_{f}}{{t}_{0}} )}^{1 / m}$$

$$with$$

$${c}_{f} = f ( T , ϕ )$$

The linear fatigue performance characterization slope 310 and y-intercept 320 are determined based on various loading angles φ and temperature values T. First, slope m 310 is determined. This slope 310 is based on multiple data points determined using different stresses at loading angle φ° and temperature T ° C., such as the points shown in FIG. 3A for φ=90° and T=T1° C. To improve the slope calculation, five or more average data points may be used to determine the slope 310. Second, the orientation dependence c_{f}=f(φ) is determined using the Hill Criterion. This orientation dependence is based on y-intercept 320 at multiple different loading angles (φ) 330 at T ° C. per the shape of the Hill yield criterion, shown in FIG. 3C. Third, the temperature dependence c_{f}=f(T) is determined using c_{f}=c·exp(nT), such as shown in FIG. 3D. The values constant c and exponential slope n are determined based on three or more different temperatures (e.g., reference points c_{f}) at φ°. Combining all models, the linear fatigue performance characterization is determined for various loading angles φ and temperature values T.

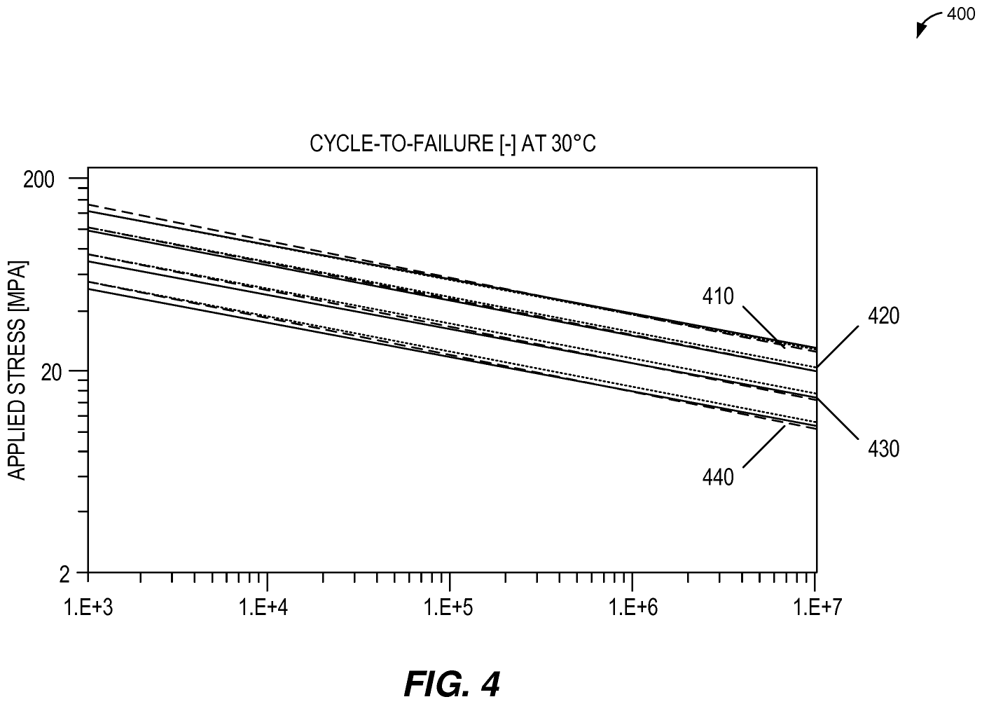

FIG. 4 shows a graph of a tensile fatigue test result evaluation 400. The tensile fatigue test result evaluation 400 demonstrates the reliability of the accelerated testing protocol. This accelerated testing protocol requires selecting a reference temperature and a reference load angle to perform smart redacted tests. The tensile fatigue test result evaluation 400 shows the sensitivity of the generated virtual fatigue data for a temperature of 30° C. for various combinations of reference temperatures and load angles. FIG. 4 shows the cycle-to-failure resulting from a constant maximum stress applied at four different orientations: 0° (i.e., aligned) 410, 22.5° 420, 45° 430, and 90° (i.e., perpendicular) 440. Solid lines show accelerated testing protocol predicted values results based on experimental data at all temperatures and orientations, dotted lines show accelerated testing protocol predicted values results based on a reference temperature T=90° C. and φ=90°, and dashed lines show accelerated testing protocol predicted values based on a reference temperature T=110° C. & φ=45°. The consistency between the dotted, dashed, and solid lines demonstrates the ability of the accelerated testing protocol to generate accurate virtual fatigue data independent of the choice of reference configurations.

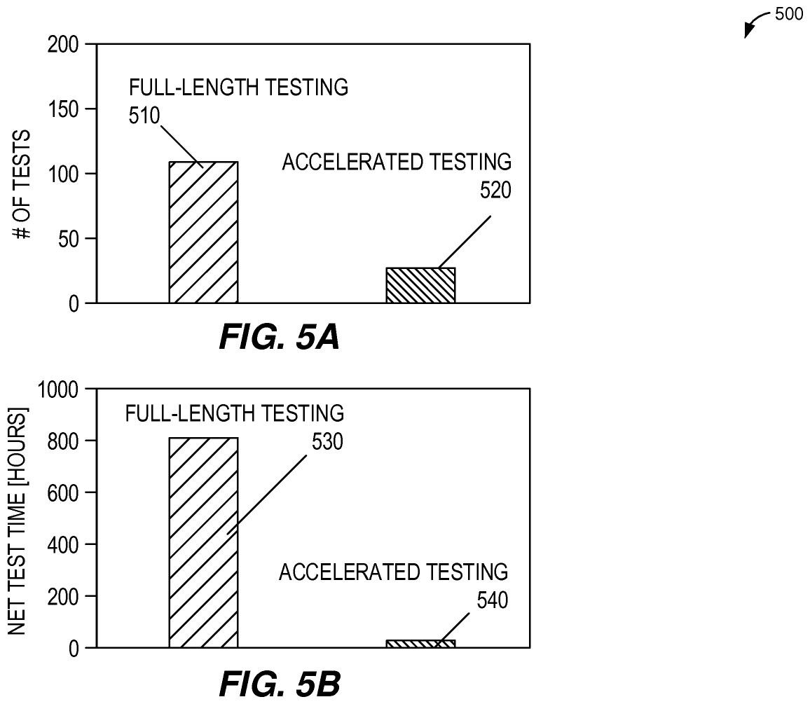

FIGS. 5A-5B show graphs of test improvement metrics 500 when using the accelerated testing protocol. To generate virtual fatigue data over a broad range of test configurations, the accelerated testing protocol uses initial limited test data to fit parameters of the models. As shown in FIG. 5A, when compared to full-length testing 510, the accelerated testing 520 provides a significant reduction in the number of tests. As shown in FIG. 5B, when compared to full-length testing 530, the accelerated testing 540 provides a significant reduction in the net test time (i.e., netto testing time).

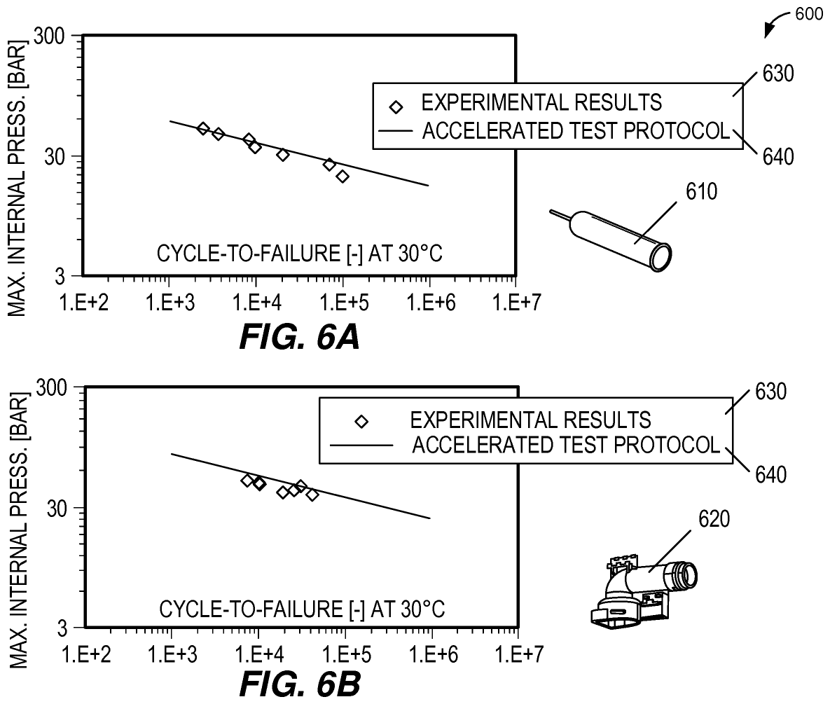

FIGS. 6A-6B show graphs of simulation validation results 600. The validation results 600 show the ability of the accelerated test protocol to predict the anisotropic mechanical performance of two different fiber-reinforced thermoplastic parts as a function of their processing-dependent morphological features. Failure prediction methodologies typically require extensive long-term testing to generate required inputs to provide long-term performance and time-to-failure or cycle-to-failure prediction. The accelerated test protocol described herein reduces or eliminates this extensive testing, and instead uses a limited set of testing to provide accurate anisotropic mechanical performance predictions.

The accelerated test protocol is validated using two fiber-reinforced thermoplastic components with different geometric complexities. FIG. 6A shows a pressure vessel 610 that is formed via injection molding. Because pressure vessel 610 is formed from the top (e.g., upper left in FIG. 6A), the reinforcing fibers are predominantly uniformly aligned with the elongated shape of the pressure vessel 610 (e.g., upper left to lower right in FIG. 6A). FIG. 6B shows a complex elbow pipe 620, which is representative of the nonuniform and complex distribution of various fiber alignments, such as may be seen in various fiber-reinforced thermoplastic products. Both of these components were tested using fluctuating internal water pressure. The temperature of water was set to 30° C., and the pressure tests were performed at a constant pressure fluctuation frequency of 1 Hz and an R ratio (i.e., the ratio of the minimum internal pressure to the maximum internal pressure) of 0.1.

FIGS. 6A-6B show the measured cycle-to-failure for each maximum internal pressure load level. The solid lines 640 represent simulation results using the virtual material data as generated by the accelerated test protocol based on predicted anisotropic input material data at 30° C. The diamond data points 630 represent experimental cycle-to-failure test results under the same conditions. As is shown in FIGS. 6A-6B, the accelerated testing protocol simulation results 640 provide accurate predictions of the experimental cycle-to-failure test results 630 over a range of internal pressure load levels. Also, the input material data used in the accelerated testing protocol was predicted and not measured, further validating the predictive ability of the accelerated testing protocol.

To better illustrate the method and apparatuses disclosed herein, a non-limiting list of embodiments is provided here.

Example 1 is a fiber-reinforced thermoplastic anisotropic failure accelerated test protocol system comprising: a test device to: failure test a fiber-reinforced thermoplastic component; and generate limited fiber-reinforced thermoplastic test data based on the failure testing; and a processor to: receive anisotropic input material data for the fiber-reinforced thermoplastic component; and generate an anisotropic failure prediction function based on the input material data and the test data, the anisotropic failure prediction function representing virtual data characterizing a functional relationship between a plurality of cycle-to-failure values and a plurality of cyclic stress magnitudes.

In Example 2, the subject matter of Example 1 optionally includes the processor further to generate a plurality of stress and strain values for the fiber-reinforced thermoplastic component based on the generated anisotropic failure prediction function.

In Example 3, the subject matter of any one or more of Examples 1-2 optionally include wherein: failure testing the fiber-reinforced thermoplastic component includes fatigue testing the fiber-reinforced thermoplastic component; and the processor further to generate a linear anisotropic fatigue failure approximation on a double logarithmic scale of the functional relationship between the plurality of cycle-to-failure values and the plurality of cyclic stress magnitudes.

In Example 4, the subject matter of any one or more of Examples 1-3 optionally include wherein: failure testing the fiber-reinforced thermoplastic component includes creep testing the fiber-reinforced thermoplastic component; and the processor further to generate a linear anisotropic creep failure approximation on a double logarithmic scale of the functional relationship between the plurality of cycle-to-failure values and the plurality of cyclic stress magnitudes.

In Example 5, the subject matter of any one or more of Examples 2-4 optionally include the processor further to determine a linear approximation slope based on the received fiber-reinforced thermoplastic test data.

In Example 6, the subject matter of Example 5 optionally includes the processor further to determine an orientation dependence of the fiber-reinforced thermoplastic component based on the received anisotropic input material data.

In Example 7, the subject matter of Example 6 optionally includes wherein the processor determining the orientation dependence of the fiber-reinforced thermoplastic component is based on an application of a Hill criterion to the received anisotropic input material data over a plurality of different loading angles.

In Example 8, the subject matter of Example 7 optionally includes the processor further to determine a temperature dependence of the fiber-reinforced thermoplastic component based on the received anisotropic input material data.

In Example 9, the subject matter of any one or more of Examples 1-8 optionally include wherein the received anisotropic input material data includes measured material data for the fiber-reinforced thermoplastic component.

In Example 10, the subject matter of any one or more of Examples 1-9 optionally include wherein the received anisotropic input material data includes predicted material data for the fiber-reinforced thermoplastic component.

In Example 11, the subject matter of any one or more of Examples 1-10 optionally include wherein: the fiber-reinforced thermoplastic component includes a uniform reinforcement fiber alignment; and the processor generating the anisotropic failure prediction function is further based on the uniform reinforcement fiber alignment.

In Example 12, the subject matter of any one or more of Examples 1-11 optionally include wherein: the fiber-reinforced thermoplastic component includes a nonuniform reinforcement fiber alignment; and generating the anisotropic failure prediction function is further based on the nonuniform reinforcement fiber alignment.

Example 13 is a fiber-reinforced thermoplastic anisotropic failure accelerated test protocol method comprising: receiving limited anisotropic input material data for a fiber-reinforced thermoplastic component; receiving fiber-reinforced thermoplastic test data from failure testing of the fiber-reinforced thermoplastic component; and generating an anisotropic failure prediction function based on the limited input material data and the test data, the anisotropic failure prediction function representing a functional relationship between a plurality of failure values and a plurality of stress magnitudes.

In Example 14, the subject matter of Example 13 optionally includes wherein receiving fiber-reinforced thermoplastic test data from failure testing includes receiving fiber-reinforced thermoplastic test data from fatigue testing of the fiber-reinforced thermoplastic component.

In Example 15, the subject matter of any one or more of Examples 13-14 optionally include wherein receiving fiber-reinforced thermoplastic test data from failure testing includes receiving fiber-reinforced thermoplastic test data from creep testing of the fiber-reinforced thermoplastic component.

In Example 16, the subject matter of any one or more of Examples 13-15 optionally include wherein: the plurality of failure values includes a plurality of cycle-to-failure values; and the plurality of stress magnitudes includes a plurality of cyclic stress magnitudes.

In Example 17, the subject matter of any one or more of Examples 13-16 optionally include wherein: the plurality of failure values includes a plurality of time-to-failure values; and the plurality of stress magnitudes includes a plurality of constant applied stress magnitudes.

In Example 18, the subject matter of any one or more of Examples 13-17 optionally include generating a plurality of stress and strain values for the fiber-reinforced thermoplastic component based on the generated anisotropic failure prediction function.

In Example 19, the subject matter of any one or more of Examples 13-18 optionally include wherein generating the anisotropic failure prediction function includes generating a linear anisotropic failure approximation on a double logarithmic scale of the functional relationship between the plurality of failure values and the plurality of stress magnitudes.

In Example 20, the subject matter of Example 19 optionally includes wherein generating the linear anisotropic failure approximation includes determining a linear approximation slope based on the received fiber-reinforced thermoplastic test data.

In Example 21, the subject matter of Example 20 optionally includes wherein generating the linear anisotropic failure approximation includes determining an orientation dependence of the fiber-reinforced thermoplastic component based on the received anisotropic input material data.

In Example 22, the subject matter of Example 21 optionally includes wherein determining the orientation dependence of the fiber-reinforced thermoplastic component is based on an application of a Hill criterion to the received anisotropic input material data over a plurality of different loading angles.

In Example 23, the subject matter of Example 22 optionally includes wherein generating the linear anisotropic failure approximation includes determining a temperature dependence of the fiber-reinforced thermoplastic component based on the received anisotropic input material data.

In Example 24, the subject matter of any one or more of Examples 13-23 optionally include wherein the received anisotropic input material data includes measured material data for the fiber-reinforced thermoplastic component.

In Example 25, the subject matter of any one or more of Examples 13-24 optionally include wherein the received anisotropic input material data includes predicted material data for the fiber-reinforced thermoplastic component.

In Example 26, the subject matter of any one or more of Examples 13-25 optionally include wherein: the fiber-reinforced thermoplastic component includes a uniform reinforcement fiber alignment; and generating the anisotropic failure prediction function is further based on the uniform reinforcement fiber alignment.

In Example 27, the subject matter of any one or more of Examples 13-26 optionally include wherein: the fiber-reinforced thermoplastic component includes a nonuniform reinforcement fiber alignment; and generating the anisotropic failure prediction function is further based on the nonuniform reinforcement fiber alignment.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Inventive subject matter can lie in less than all features of a particular disclosed embodiment. Thus, the following claims are hereby incorporated into the Detailed Description, with each claim standing on its own as a separate embodiment. The scope of the subject matter of this patent application should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects or a requirement of order.

Method examples described herein can be machine or computer-implemented, at least in part, such as with a computer or machine-readable medium encoded with instructions to configure an electronic device to perform method steps as described in the above examples. An implementation of such methods can include code, e.g., microcode, assembly language code, a higher-level language code. Such code can include computer-readable instructions to perform method steps. The code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Although the subject matter of this patent application has been described with reference to exemplary embodiments, workers skilled in the art will recognize that changes may be made in form and detail without departing from the spirit and scope of the subject matter.

1. A fiber-reinforced thermoplastic anisotropic failure accelerated test protocol system comprising:
a test device to:
failure test a fiber-reinforced thermoplastic component; and
generate limited fiber-reinforced thermoplastic test data based on the failure testing; and
a processor to:
receive anisotropic input material data for the fiber-reinforced thermoplastic component; and
generate an anisotropic failure prediction function based on the input material data and the test data, the anisotropic failure prediction function representing virtual data characterizing a functional relationship between a plurality of cycle-to-failure values and a plurality of cyclic stress magnitudes.

2. The system of claim 1, the processor further to generate a plurality of stress and strain values for the fiber-reinforced thermoplastic component based on the generated anisotropic failure prediction function.

3. The system of claim 1, wherein:
failure testing the fiber-reinforced thermoplastic component includes fatigue testing the fiber-reinforced thermoplastic component; and
the processor further to generate a linear anisotropic fatigue failure approximation on a double logarithmic scale of the functional relationship between the plurality of cycle-to-failure values and the plurality of cyclic stress magnitudes.

4. The system claim 1, wherein:
failure testing the fiber-reinforced thermoplastic component includes creep testing the fiber-reinforced thermoplastic component; and
the processor further to generate a linear anisotropic creep failure approximation on a double logarithmic scale of the functional relationship between the plurality of cycle-to-failure values and the plurality of cyclic stress magnitudes.

5. The system of claim 2, the processor further to determine a linear approximation slope based on the received fiber-reinforced thermoplastic test data.

6. The system of claim 5, the processor further to determine an orientation dependence of the fiber-reinforced thermoplastic component based on the received anisotropic input material data.

7. The system of claim 6, wherein the processor determining the orientation dependence of the fiber-reinforced thermoplastic component is based on an application of a Hill criterion to the received anisotropic input material data over a plurality of different loading angles.

8. The system of claim 7, the processor further to determine a temperature dependence of the fiber-reinforced thermoplastic component based on the received anisotropic input material data.

9. The system claim 1, wherein:
the fiber-reinforced thermoplastic component includes a uniform reinforcement fiber alignment; and
the processor generating the anisotropic failure prediction function is further based on the uniform reinforcement fiber alignment.

10. The system claim 1, wherein:
the fiber-reinforced thermoplastic component includes a nonuniform reinforcement fiber alignment; and
generating the anisotropic failure prediction function is further based on the nonuniform reinforcement fiber alignment.

11. A fiber-reinforced thermoplastic anisotropic failure accelerated test protocol method comprising:
receiving limited anisotropic input material data for a fiber-reinforced thermoplastic component;
receiving fiber-reinforced thermoplastic test data from failure testing of the fiber-reinforced thermoplastic component; and
generating an anisotropic failure prediction function based on the limited input material data and the test data, the anisotropic failure prediction function representing a functional relationship between a plurality of failure values and a plurality of stress magnitudes.

12. The method of claim 11, wherein receiving fiber-reinforced thermoplastic test data from failure testing includes receiving fiber-reinforced thermoplastic test data from fatigue testing of the fiber-reinforced thermoplastic component.

13. The method of claim 11, wherein receiving fiber-reinforced thermoplastic test data from failure testing includes receiving fiber-reinforced thermoplastic test data from creep testing of the fiber-reinforced thermoplastic component.

14. The method of claim 11, wherein:
the plurality of failure values includes a plurality of cycle-to-failure values; and
the plurality of stress magnitudes includes a plurality of cyclic stress magnitudes.

15. The method of claim 11, wherein:
the plurality of failure values includes a plurality of time-to-failure values; and
the plurality of stress magnitudes includes a plurality of constant applied stress magnitudes.

16. The method of claim 11, further including generating a plurality of stress and strain values for the fiber-reinforced thermoplastic component based on the generated anisotropic failure prediction function.

17. The method of claim 11, wherein generating the anisotropic failure prediction function includes generating a linear anisotropic failure approximation on a double logarithmic scale of the functional relationship between the plurality of failure values and the plurality of stress magnitudes.

18. The method of claim 17, wherein generating the linear anisotropic failure approximation includes determining a linear approximation slope based on the received fiber-reinforced thermoplastic test data.

19. The method of claim 18, wherein generating the linear anisotropic failure approximation includes determining an orientation dependence of the fiber-reinforced thermoplastic component based on the received anisotropic input material data.

20. The method of claim 19, wherein determining the orientation dependence of the fiber-reinforced thermoplastic component is based on an application of a Hill criterion to the received anisotropic input material data over a plurality of different loading angles.
